(19) United States
(12) Patent Application Publication
(10) Pub. No.: US 2008/0022831 A1
(43) Pub. Date: Jan. 31, 2008

(54) Thin-Film Slicer

(75) Inventors: Mitsuo Watanabe, Tokyo (JP); Fumiko Kaneuchi, Tokyo (JP)

Correspondence Address: RANKIN, HILL, PORTER & CLARK, LLP, 925 EUCLID AVENUE, SUITE 700, CLEVELAND, OH, 44115-1405, US

(73) Assignee: JASCO CORPORATION, Tokyo (JP)

(21) Appl. No.: 11/832,680

(22) Filed: Aug. 2, 2007

Related U.S. Application Data
(62) Division of application No. 11/000,847, filed on Dec. 1, 2004.

(30) Foreign Application Priority Data
Dec. 5, 2003 (JP) 2003-407595

(51) Int. Cl. B26D 7/06

(52) U.S. Cl. 83/707

(57) ABSTRACT

A thin-film slicer is disclosed that comprises a base; a sample holder; a cutting blade; and a feeder, wherein the sample holder and the cutting blade are placed at predetermined angles with respect to the base; the sample holder sandwiches the sample surfaces of the thin film at a portion other than a portion to be cut; the cutting blade is provided movably in a straight line in a direction that forms the predetermined angle with respect to the direction of the sample surfaces of the thin film, and cuts the thin film held by the sample holder from a sample-surface side; and the feeder feeds the cutting blade in a straight line in the direction that forms the predetermined angle with respect to the sample surfaces of the thin film held by the sample holder.

### RELATED APPLICATIONS

This application claims priority to the Japanese Patent Application 2003-407595 dated on Dec. 5, 2003 and is hereby incorporated with reference for all purposes.

### BACKGROUND OF THE INVENTION

1. Field of the Invention

The present invention relates to thin-film slicer, and more particularly, to improvement of its cutting mechanism.

1. Prior Art

Thin films such as various types of packing films, cards, vinyl bags, printed materials, and applied films often have a multi-layer-film structure. Measurement of the components of the multi-layer-film structure and thickness measurement of each layer are demanded for such thin films.

To meet this demand, it is necessary to produce a suitable surface of the thin film or to make a slice of thin film. To this end, it is conventionally considered that standard slicers for thinly cutting a sample which is in a form of a block are used; such slicers, however, are not designed for cutting thin films. Such standard slicers include, for example, a microtome for thinly cutting a sample which is in a form of a block (disclosed in Japanese Unexamined Patent Application Publication No. Hei-5-26792) and a slicer for slicing a block of fish or meat (disclosed in Japanese Unexamined Patent Application Publication No. Hei-9-300287).

When standard slicers are used for cutting a thin film, it is necessary to embed the thin film in resin first to obtain the necessary cutting strength. After the resin is hardened, the resin is placed in a slider, and a thin-film slice is made.

These standard slicers are very expensive. Moreover, since it is necessary to embed the thin film in resin to have sufficient cutting strength, time and labor are required. Therefore, if standard slicers are used for cutting thin films, there remains room for improvement in terms of the cost of the slicers and the ease of making slices. A conventional technology that solves these issues at the same time does not exist.

### SUMMARY OF THE INVENTION

The present invention has been made in view of the above-described issues of the conventional technology. An object of the present invention is to provide a thin-film slicer capable of easily making thin-film slices.

The thin-film slicer of the present invention to achieve the above object is a thin-film slicer comprising a base, a sample holder, a cutting blade, and a feeder.

In this case, the sample holder and the cutting blade are placed at predetermined angles with respect to the base such that an angle determined based on a desired cutting-plane angle is formed between a direction of sample surfaces opposite each other in the thickness direction of a thin film and a feeding direction of the cutting blade.

The sample holder sandwiches the sample surfaces of the thin film at a portion other than a portion to be cut, such that the direction of the sample surfaces of the thin film and the feeding direction of the cutting blade form a predetermined angle.

The cutting blade is provided movably in a straight line in a direction that forms the predetermined angle with respect to the direction of the sample surfaces of the thin film. The cutting blade cuts the thin film held by the sample holder from a sample-surface side.

The feeder feeds the cutting blade in a straight line in the direction that forms the predetermined angle with respect to the sample surfaces of the thin film held by the sample holder.

In the above-described thin-film slicer, it is preferred that the sample holder sandwiches a thin film having a multi-layer-film structure.

<Vertical Slicer>

In the above-described thin-film slicer, it is preferred that, the feeder comprises a vertical linear guide and a vertical slider. The sample holder sandwiches the sample surfaces of the thin film at a portion other than the portion to be cut, such that the sample surfaces of the thin film are directed horizontally. The vertical slider is fed perpendicularly to the sample surfaces of the thin film to cut the thin film held by the sample holder with the cutting blade in the direction perpendicular to the sample surfaces. In the present invention, the thin-film slicer makes a thin-film slice having a cutting plane perpendicular to the sample surfaces.

In this case, the vertical linear guide is provided in a straight line in the direction perpendicular to the base.

The vertical slider is provided movably only in the direction perpendicular to the base along the vertical linear guide. The vertical slider holds the cutting blade such that the tip of the cutting blade is directed perpendicularly to the sample surfaces of the thin film.

<Tilted Slicer>

In the above-described thin-film slicer, it is preferred that, the feeder comprises a horizontal linear guide and a horizontal slider. The sample holder sandwiches the sample surfaces of the thin film at a portion other than the portion to be cut, such that the direction of the sample surfaces of the thin film forms the predetermined angle with respect to the feeding angle of the cutting blade in a state in which the portion to be cut is protruded at a tilt angle with respect to the feeding direction of the cutting blade. In the above-described thin-film slicer, the horizontal slider is fed horizontally toward the sample surfaces of the thin film to cut the thin film held by the sample holder with the cutting blade in the feeding direction of the cutting blade to make a thin-film slice having a tilt cutting-plane angle formed between the direction of the sample surfaces of the thin film and the feeding direction of the cutting blade.

In this case, the horizontal linear guide is provided in a straight line in parallel to the base.

The horizontal slider is provided movably only in parallel to the base along the horizontal linear guide. The horizontal slider holds the cutting blade such that the tip of the cutting blade is directed horizontally toward the sample surfaces of the thin film.

In the above-described thin-film slicer, it is preferred that the sample holder holds a strip-shaped thin film such that the longitudinal direction of the strip-shaped thin film is directed to the feeding direction of the cutting blade.

<Improvement in Machinability>

In the above-described thin-film slicer, it is preferred that, the thin-film slicer further comprises an angle changer. The angle changer adjusts the angle of the sample holder to adjust the angle of the sample surfaces of the thin film with respect to the feeding direction of the cutting blade to set the angle of the cutting plane with respect to the sample surfaces of the thin film to a desired angle.

In this case, the angle changer changes the angle of the sample holder with respect to the base.

In the above-described thin-film slicer, to further improve the machinability of the tilted slicer, it is preferred that the cutting blade is placed such that an end-edge direction of the tip of the blade is directed at a tilt angle with respect to the direction perpendicular to the feeding direction of the cutting blade in a plane drawn by the tip of the cutting blade.

In the above-described thin-film slicer, to further improve the machinability of the vertical slicer and/or the machinability of the tilted slicer, it is preferred that the thin-film slicer further comprises a vibrator.

In this case, the vibrator vibrates the cutting blade supersonically at a predetermined vibration amplitude and a predetermined vibration period in the feeding direction of the cutting blade fed by the feeder.

### BRIEF DESCRIPTION OF THE DRAWINGS

FIG. 1 is a view showing a vertical slicer according to a first embodiment of the present invention.

FIG. 2 is a view showing action according to the vertical slicer in FIG. 1.

FIG. 3 is a view showing a tilted slicer according to a second embodiment of the present invention.

FIG. 4 is a view showing action according to the tilted slicer in FIG. 3.

FIG. 5 is a view showing a preferred arrangement of the cutting blade according to the tilted slicer in FIG. 3.

FIG. 6 is a view showing a vibrator which is suited to the cutting blade according to the embodiments of the present invention.

### DESCRIPTION OF THE PREFERRED EMBODIMENT

Embodiments of the present invention will be described below by referring to the drawings.

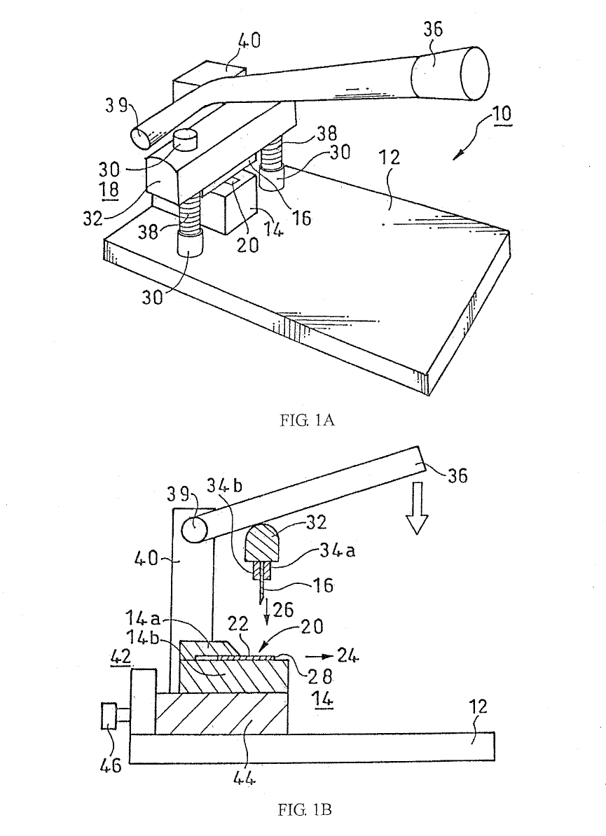

FIGS. 1A and 1B show an outline structure of a thin-film slicer according to an embodiment of the present invention.

In the figures, a thin-film slicer 10 includes a fixed base 12, a sample holder 14, a cutting blade 16, and a feeder 18.

In the thin-film slicer 10, the sample holder 14 and the cutting blade 16 are placed at predetermined angles with respect to the base 12 such that an angle determined based on a desired cutting-plane angle is obtained between the direction 24 of sample surfaces 22 opposite each other in the thickness direction of a thin film 20 and the feeding direction 26 of the cutting blade 16.

The sample holder 14 sandwiches the sample surfaces 22 of the thin film 20 at a portion other than a portion 28 to be cut, such that the sample-surface direction 24 of the thin film 20 and the feeding direction 26 of the cutting blade 16 form a predetermined angle.

The cutting blade 16 is provided movably in a straight line in the direction 26, which forms the predetermined angle with the sample surfaces 22 of the thin film 20. The cutting blade 16 cuts the thin film 20 held by the sample holder 14 from the side of the sample surfaces 22.

The feeder 18 feeds the cutting blade 16 in a straight line in the direction 26, which forms the predetermined angle with the sample surfaces 22 of the thin film 20 held by the sample holder 14.

In the thin-film slicer 10, the cutting blade 16 is fed in a straight line in the predetermined direction with respect to the sample surfaces 22 of the thin film 20. With this operation, the thin film 20 is cut from the side of the sample surfaces 22 at the angle formed by the sample-surface direction 24 and the feeding direction 26 of the cutting blade 16 in the thin-film slicer 10.

The thin-film slicer 10 according to the present invention will be described below more specifically.

### First Embodiment

(Vertical Slicer)

In the present invention, it is preferred that a vertical slicer be used for making a suitable surface of film having, for example, a thickness of about 30 μm to 1 mm and for making a thin-film slice having, for example, a thickness of about 30 μm to 1 mm. Since the vertical slicer cuts the thin film perpendicularly to its sample surfaces, it is suited to layer-thickness measurement at a cutting plane 47. An obtained slice can be disc-molded with the use of a KBr plate or a mini-plate for layer identification by infrared transmission microscopy. A suitable film thickness for cutting is about 30 μm to 650 μm.

FIGS. 1A and 1B show an outline stricture of a vertical slicer according to an embodiment of the present invention. FIG. 1A is an outline perspective view of the vertical slicer according to the present embodiment, and FIG. 1B is an equivalent view showing a vertical cross-section of a main part thereof.

In the present embodiment, the sample holder holds a strip-shaped thin film having a multi-layer-film structure, and the vertical slicer cuts the thin film perpendicularly to its sample surfaces.

In the vertical slicer (thin-film slicer) 10, sample holders 14a and 14b and the cutting blade 16 are placed with respect to the base 12 such that the angle formed by the sample-surface direction 24 of the thin film 20 and the feeding direction 26 of the cutting blade 16 is 90 degrees.

The sample holders 14a and 14b sandwich the thin film 20 at a portion on the sample surfaces 22 other than the portion 28 to be cut, such that the sample-surface direction 24 of the thin film 20 is horizontal.

The feeder 18 includes vertical linear guides 30 and a vertical slider 32.

The vertical linear guides 30 are provided in a straight line perpendicularly to the base 12.

The vertical slider 32 is provided movably only in the direction perpendicular to the base 12 along the vertical linear guides 30. At a lower-end section of the vertical slider 32, blade holders 34a and 34b hold the cutting blade 16 such that the blade tip is directed in the direction perpendicular to the sample surfaces 22 of the thin film 20.

In the present embodiment, the vertical slider 32 is fed perpendicularly to the sample surfaces 22 of the thin film 20. With this operation, the cutting blade 16 cuts the thin film 20 held by the sample holders 14a and 14b in the direction 26 perpendicular to the sample surfaces 22. As a result, a thin-film slice having a cutting plane perpendicular to the sample surfaces 22 is made in the present embodiment.

In the present embodiment, the feeder 18 further includes a lever 36 and springs 38.

One end of the lever 36 serves as a shaft 39 supported by a post 40 which stands upright from the base 12. The lever 36 can be rotated about the shaft 39. The lever 36 is abutted against an upper end of the vertical slider 32 at the middle thereof.

The springs 38 are provided at outer portions of the vertical linear guides 30. Upper ends of the springs 38 are abutted against lower ends of the vertical slider 32.

In the present embodiment, the sample holder 14 is placed on the base 12 with a horizontal feeder 42 placed therebetween. The horizontal feeder 42 includes a linear guide 44, a lower-side sample holder 14b serving as a slider, and a dial 46. The linear guide 44 is provided on the base 12 in the longitudinal direction (the right and left directions in the figure) of the strip-shaped thin film 20. In the present embodiment, when the dial 46 is rotated, the lower-side sample holder 14b is fed horizontally in the right and left directions in the figure on the linear guide 44. With this operation, since the thin film 20 can be fed horizontally in its longitudinal direction, the length of a thin-film slice can be adjusted.

In the present embodiment, the length of a thin-film slice is adjusted first by using the horizontal feeder 42, and then the thin-film slice is made.

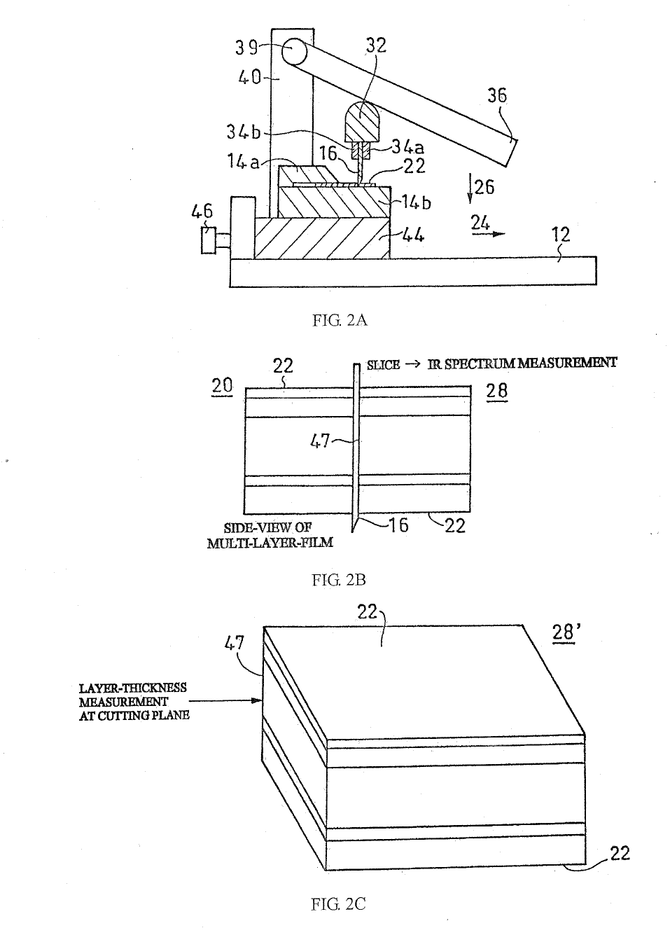

More specifically, as shown in FIG. 1B, the thin film 20 is sandwiched by the fixed sample holders 14a and 14b at the sample surfaces 22 with the sample-surface direction 24 being directed horizontally. Then, as shown in FIG. 2A, the vertical slider 32 is fed vertically downward by operating the lever 36. The blade tip of the cutting blade 16 is abutted against the sample surfaces 22 of the fixed thin film 20 vertically, and cuts the thin film 20, as shown in FIG. 2B.

In the present embodiment, when downward force applied to the lever 36 downward is reduced or the lever 36 is moved upward, the vertical slider 32 rises with the restoration force of the springs 38.

As a result, in the present embodiment, a thin-film slice 28′ having an angle of 90 degrees formed between the cutting plane 47 and the sample surfaces 22 is made, as shown in FIG. 2C.

Layer-thickness measurement is performed for the thin-film slice 28′ obtained in this way at the cutting plane 47. The thin-film slice 28′ is also disc-molded with the use of a KBr plate for layer identification at the cutting plane 47 by infrared transmission microscopy.

Microtomes for cutting a bulk sample have been conventionally used as slicers, although they are not thin-film slicers. Microtomes might be used for making thin-film slices but there is no established method for making them.

Microtomes are very expensive. Moreover, if the cutting strength is insufficient, the thin film must be embedded in a resin to have sufficient cutting strength. However, such a conventional method needs time and labor. Furthermore, microtomes do not have any mechanism for setting the angle of the cutting plane because they are not designed for cutting, for example, thin films having a multi-layer-film structure. Therefore, conventionally, to obtain thin-film slices having different cutting-plane angles, it is necessary to use microtomes that provide different cutting-plane angles. In addition, it is difficult for microtomes to always provide the desired cutting-plane angles. General microtomes are of a rotation type, and the blade tip of a cutting blade or a sample is moved along an arc. Therefore, the cutting plane of the thin film made by microtomes is not exactly straight, but is arc shaped. If the cutting plane is not straight but arc shaped, correct layer-thickness measurement is difficult to achieve.

The present inventors have found after careful investigation that, to make a thin-film slice 28′ at a desired cutting-plane angle easily, it is important that the angle formed by the sample-surface direction 24 of the thin film 20 and the feeding direction 26 of the cutting blade 16 be first set to 90 degrees, which is a desired cutting-plane angle. In the present invention, it was found that it is important to feed the cutting blade 16 in a straight line in the direction 26 perpendicular to the sample-surface direction 24 of the thin film 20.

It was also found that it is very important to employ a combination of the following three most suitable methods (1) to (3) to make the thin-film slice 28′.
(1) Among many methods for positioning a thin film, a method for sandwiching the thin film 20 at opposing sample surfaces in the thickness direction of the thin film 20 is selected as the most-suitable method for positioning a thin film to make thin-film slices.
(2) Among many methods for placing the cutting blade 16, a method for placing the cutting blade 16 so that the tip thereof is directed toward the sample surfaces 22 of the thin film 20 is selected as the most-suitable method for placing the cutting blade to make thin-film slices.
(3) Among many feeding methods, a method for feeding the cutting blade 16 in a straight line toward the sample surfaces 22 of the thin film 20, with the sample holders 14a and 14b for holding the thin film 20 being fixed, is selected as the most-suitable feeding method to make thin-film slices.

In the present embodiment, a combination of the most-suitable methods (1) to (3) for making thin-film slices improves the operability of the slicer 10. More specifically, in the present embodiment, the thin film 20 is not fixed in resin but sandwiched as is by the sample holders 14a and 14b, and the vertical slider 32 is just fed vertically downward. Therefore, in the present embodiment, the slicer quickly makes the thin-film slice 28′at an angle of 90 degrees at the cutting plane 47. Hence, even inexperienced users can easily cut thin films with the slicer.

When the cutting blade 16 is detachably mounted to the blade holders 34a and 34b, commercially available blades can be used as the cutting blade 16. With this feature, the present embodiment reduces the running cost considerably. Moreover, since the thickness of a slice can be changed by operating the lever 36, the thickness is variable. The thin-film slice 28′ is unlikely to be affected by an adjacent layer in infrared measurement.

<Second Embodiment>

(Tilted Slicer)

The above-described vertical slicer is suited to layer-thickness measurement at the cutting plane because the cutting plane is perpendicular to the sample surfaces. On the other hand, when a tilted slicer is used, the cutting plane is much larger compared with the cutting plane obtained by vertical cutting, and a thin layer is more easily detected among multiple layers. Therefore, to increase the size of the cutting plane, it is preferred that a tilted slicer be used with horizontal feeding with respect to a fixed thin film to cut the thin film at an angle.

It is preferred that a tilted slicer be used for making a suitable cutting surface of film having a thickness of about 10 μm to several hundred micrometers and for making a thin-film slice having a thickness of about 10 μm to several hundred micrometers. The cutting plane of a thin-film slice made by the tilted slicer is larger compared with that produced by vertical cutting. Therefore, a thin film is easily detected among multiple layers. Hence, the tilted slicer can be used for determining whether foreign matter exists in a plane, for making a surface of a fish-eye lens, for determining whether a laminated layer has been made properly, and so on. The most suitable film thickness for cutting in the tilted slicer is about 40 μm to 130 μm.

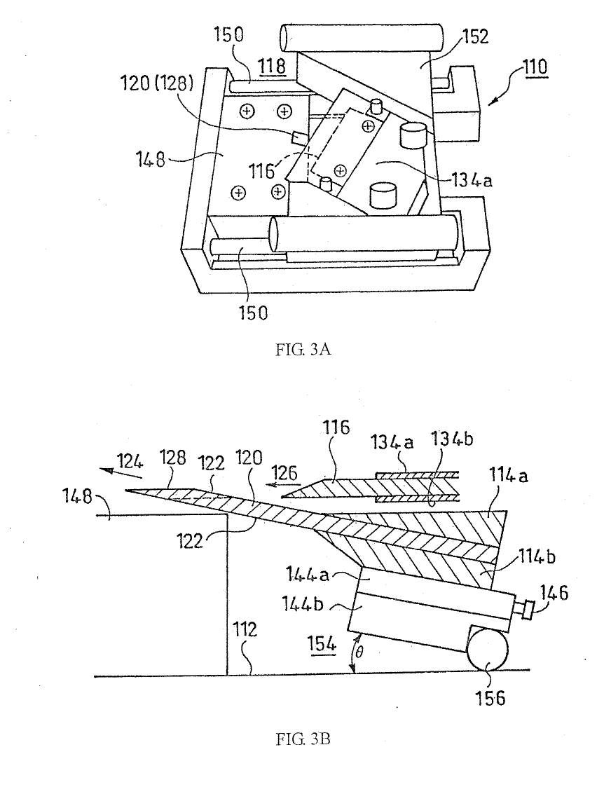

FIGS. 3A and 3B show an outline structure of a tilted slicer according to an embodiment of the present invention.

FIG. 3A is an outline perspective view of the tilted slicer according to the present invention. FIG. 3B is an equivalent view of a vertical cross-section of a main part thereof. Elements corresponding to those described in the first embodiment are assigned the same numerals as those described in the first embodiment plus 100, and a description of those elements is omitted.

In the present embodiment, a thin film is cut at an angle with respect to sample surfaces of the thin film.

In the tilted slicer (thin-film slicer) 110 shown in FIGS. 3A and 3B, sample holders 114a and 114b sandwich a thin film 120 at a portion on the sample surfaces 122 other than a portion 128 to be cut, such that a sample-surface direction 124 of the thin film 120 forms a predetermined angle with a feeding direction 126 of a cutting blade 116, in a state in which the portion 128 of the thin film 120 to be cut protrudes at an angle with respect to the feeding direction 126 of the cutting blade 116.

The sample holders 114a and 114b are placed on a base 112 with a very slight clearance from a block section 148 in the horizontal direction. The portion 128 of the thin film 120 to be cut is protruded from the sample holders 114a and 114b by a small amount that does not cause the thin film 120 to be bent by its own weight or to be bent when cut, toward the feeding direction 126 of the cutting blade 116.

A feeder 118 includes horizontal linear guides 150 and a horizontal slider 152.

The horizontal linear guides 150 are provided in a straight line in parallel to the base 112.

The horizontal slider 152 is provided movably only in parallel to the base 112 along the horizontal linear guides 150. The horizontal slider 152 holds the cutting blade 116 such that the blade tip of the cutting blade 116 is directed toward the sampling surface 122 of the thin film 120 in the horizontal direction.

In the present embodiment, the horizontal slider 152 is horizontally fed toward the sample surfaces 122 of the thin film 120 to cut the thin film 120 sandwiched by the sample holders 114a and 114b with the cutting blade 116 in the feeding direction 126 of the cutting blade 116. As a result, in the present embodiment, a thin-film slice 128′ is made in which a cutting plane 147 has a tilt angle formed by the sample-surface direction 124 of the thin film 120 and the feeding direction 126 of the cutting blade 116.

In the present embodiment, by changing the angle of the cutting plane 147 of the thin film 120, the amount by which each layer is projected onto the cutting plane 147 is changed. Therefore, it is preferred that an angle changer 154 be also provided in the present embodiment.

The angle changer 154 includes, for example, a shaft 156. In the present embodiment, the sample holders 114a and 114b are provided swingably in the directions indicated by arrows in the figure on the base 112 via the shaft 156.

In the present embodiment, just by changing the angle θ of the sample holders 114a and 114b with respect to the base 112, the sample-surface direction 124 of the thin film 120 with respect to the feeding direction 126 of the cutting blade 116 is changed. Therefore, the angle of the cutting plane 147 of the thin film 120 can be easily changed to a desired angle.

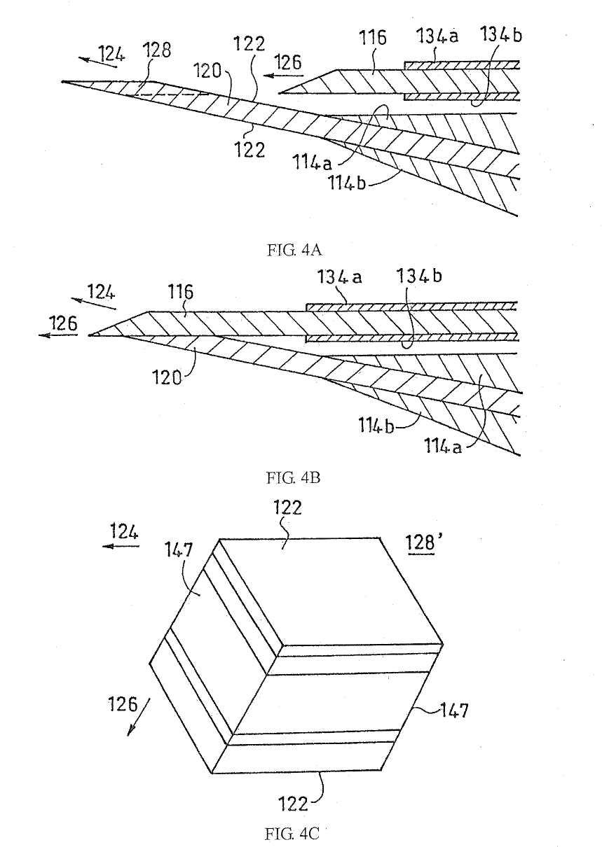

In the present embodiment, as shown in FIG. 4A, the thin film 120 is sandwiched by the sample holders 114a and 114b in a state in which the sample surfaces 122 are at an angle with respect to the feeding direction 126.

When the horizontal slider 152 is horizontally fed toward the sample surfaces 122 of the thin film 120, the tip of the cutting blade 116 is abutted at an angle against the sample surfaces 122 of the thin film 120, as shown in FIG. 4B, to cut the thin film 120.

As a result, in the present embodiment, a thin-film slice 128′ having a cutting plane 147 formed at a tilt angle made between the sample-surface direction 124 and the feeding direction 126 is made, as shown in FIG. 4C.

As described above, in the present embodiment, the angle made between the sample-surface direction 124 of the thin film 120 and the feeding direction 126 of the cutting blade 116 is set to an angle determined based on a desired cutting-plane angle. Just by horizontally feeding the horizontal slider 152 in a straight line, the thin-film slice 128′ having the cutting plane 147 with the desired tilt angle is easily made.

In the present embodiment, it is preferred that the thin film 120 be protruded, at an angle, by a small amount that does not cause the thin film 120 to be bent by its own weight or to be bent when cut. With this, the cutting plane is properly obtained with the desired tilt angle because deformation of the thin film 120 substantially does not occur during cutting. It is also preferred in the present embodiment that the thin film 120 have a strip shape and be protruded in its longitudinal direction. This prevents, to a great extent, the thin film 120 from being bent by its own weight or from being bent when cut in the feeding direction 126 of the cutting blade 116.

Conventional slicers for cutting a block of fish or meat at an angle have been used, which are not designed for cutting thin films at an angle. In these slicers, the block is just placed on a table, and the block is fed toward a fixed cutting blade. Therefore, when the slicers are used for cutting a thin film, the position of the thin film may be shifted on the table during feeding. Also, in these slicers, the cutting blade is placed such that an end-edge direction of its tip is perpendicular to the feeding direction of the block. Therefore, when these slicers are used for cutting a thin film, the thin film may be distorted because the cutting blade cuts the thin film in the direction perpendicular to the side walls of the thin film, opposing each other in the width direction. For the reasons described above, standard slicers may not be able to cut thin films. Even if these standard slicers can cut thin films, a desired tilt angle may not be obtained. In addition, these standard slicers may not be able to cut thin films properly and in a straight line.

In the present embodiment, the sample holders 114a and 114b and the cutting blade 116 are placed with respect to the base 112 such that the angle formed by the sample-surface direction 124 of the thin film 120 and the feeding direction 126 of the cutting blade 116 is set to a desired tilt angle of a cutting plane. The horizontal slider 152 is horizontally fed toward the sample surfaces 122 of the thin film 120 to cut the thin film 120 with the cutting blade 116 to make the thin-film slice 128′ having the cutting plane 147 with the tilt angle formed between the sample-surface direction 124 of the thin film 120 and the feeding direction 126 of the cutting blade 116.

As described above, the present embodiment employs a combination of the most suitable methods (1) to (3) for making thin-film slices in the same way as in the first embodiment. Therefore, the thin film is not fixed by resin but is sandwiched as is by the holders, and the horizontal slider is horizontally fed in a straight line toward the sample surfaces of the thin film. Thus, even an inexperienced user can easily make a thin-film slice having a cutting plane with a tilt angle equal to the angle formed between the sample-surface direction of the thin film and the feeding direction of the cutting blade. Therefore, the present embodiment allows anyone to achieve successful results.

As in the first embodiment, it is preferred in the present embodiment that the cutting blade 116 be detachably mounted to the blade holders 134a and 134b. With this feature, commercially available blades can be used as the cutting blade 16, which reduces the running costs considerably. In addition, the thickness of a thin-film slice can be changed in the present embodiment. Furthermore, since the slicer of the present embodiment is compact and light-weight, it can be used in a stereo-microscope. Thus, a thin film can be cut while a cutting plane is observed through the stereo-microscope. Moreover, each layer in a thin film appears larger. For example, when a thin film is cut at an angle of 15 degrees with respect to the sample surfaces, the cutting width is about four times larger compared with that in vertical cutting. Therefore, thin-film slices are more unlikely to be affected by an adjacent layer in infrared measurement.

<Improvement in Machinability>

Conventionally, a thin film is usually embedded in resin to obtain the necessary cutting strength. In the present invention, however, such a task is not needed, and a cutting blade with an increased machinability properly cuts the thin film.

The present invention provides the following ways (in third and fourth embodiments) to further improve the machinability of the cutting blade.

### Third Embodiment

(Cutting-Blade Arrangement)

When a sample is highly elastic, like soft rubber, and soft, the sample may be likely to distort during cutting.

To increase the machinability of a tilted slicer, the present embodiment pays special attention to the direction of the tip of a cutting blade.

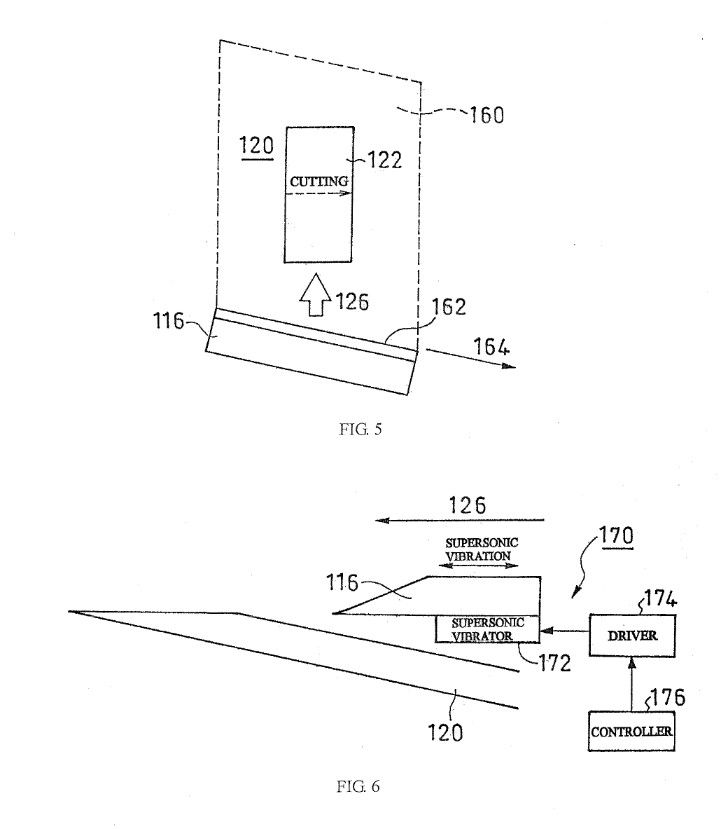

When a tilted slicer is viewed from the top as shown in FIG. 5, the cutting blade 116 is placed such that the end-edge direction 162 of the tip of the cutting blade 116 is directed in a direction 164 which is at an angle with respect to the direction perpendicular to the feeding direction 126 of the cutting blade 116 in a horizontal plane 160 drawn by the tip of the cutting blade 116.

Therefore, in the present embodiment, when the cutting blade 116 is horizontally fed toward the sample surfaces 122 of the thin-film 120, the cutting blade 116 first cuts an end of the sample surfaces 122 of the thin film 120, and then, cuts toward the other end in the width direction.

In the present embodiment, the cutting blade 116 first cuts an end of the sample surfaces 122 of the thin film 120 in this way, and then cuts further. Therefore, compared with a case in which the entire tip of a cutting blade is abutted against the sample surfaces 122, the distortion of the thin film 120 in the feeding direction 126 of the cutting blade 116 is largely reduced, and smooth cutting is achieved. With this, the present embodiment provides a cutting plane with a desired angle even for the thin-film 120.

### Fourth Embodiment

(Supersonic Vibration of Cutting Blade)

When the cutting blade 116 is manually fed, the manual-feeding speed determines the cutting speed. If a block of fish or meat is the sample, even when the cutting blade is moved up and down at a usual speed, a certain degree of machinability is obtained. However, if a thin film is cut, higher machinability is required compared with a case in which a block of fish or meat is cut.

It is preferred in the present invention that supersonic vibration be applied to the tip of the cutting blade 116 in the cutting direction, in addition to manual feeding. With this, the present invention greatly increases the cutting speed when the thin film 120 is cut. The cutting quality depends on the feeding speed of the cutting blade 116, and increases as the cutting speed increases. Since friction between the cutting blade 116 and the thin film 120 is largely reduced in the present invention, it is considered that this factor also contributes to improvement in machinability.

It is preferred in the present embodiment that a thin-film slicer according to the present invention be provided with a vibrator 170 such as that shown in FIG. 6.

The vibrator 170 shown in FIG. 6 includes a supersonic vibrator 172, a driver 174, and a controller 176.

The supersonic vibrator 172 is provided for the tip of the cutting blade 116. The supersonic vibrator 172 vibrates supersonically in the feeding direction 126 of the cutting blade 116.

The driver 174 drives the supersonic vibrator 172.

The controller 176 controls the operation of the driver 174.

It is preferred in the present embodiment that the amplitude of the vibration and the vibration period also be controlled appropriately when the cutting blade 116 is vibrated supersonically.

When the thin film is highly elastic, like soft rubber, and soft, the thin film may be likely to distort during cutting. Therefore, planar slices are difficult to obtain in some cases.

In the present embodiment, when the amplitude of vibration and the vibration period are appropriately selected for supersonic vibration, successful thin-film slices are obtained without causing distortion of the thin film. When an appropriate amplitude and an amplitude vibration period are specified for supersonic vibration in the controller 176, for example, the controller 176 controls the operation of the driver 174 such that the supersonic vibrator 172 vibrates supersonically at the specified vibration amplitude for the specified vibration period.

In the present embodiment, the vibrator 170 is provided, and the cutting blade 116 is vibrated supersonically at a predetermined vibration amplitude for a predetermined vibration period in the feeding direction 126. With this feature, the present embodiment greatly increases the machinability of the cutting blade 116 to more easily make thin-film slices.

<Modifications>

The supersonic vibration is preferably used for the vertical slicer, and is especially preferably used for the tilted slicer.

In the above-described embodiments, the slider is fed manually and the cutting angle is changed manually by the angle changer. The present invention is not limited to these embodiments, however. It is also preferred that the slider be fed automatically and the cutting angle be changed automatically by the angle changer, with the use of a motor or other means.

As described above, in a thin-film slicer according to the present invention, sample holders for sandwiching the sample surfaces of the thin film and a cutting blade provided movably in a straight line in a predetermined direction with respect to the sample surfaces of the thin film are placed at predetermined angles with respect to a base. Also in the present invention, a feeder feeds the cutting blade in a straight line in a predetermined direction with respect to the sample surfaces of the thin film. As a result, thin-film slices having a desired cutting-plane angle can be easily made.

In addition, an angle changer for changing the angle of the sample holders with respect to the base is provided in the present invention. Therefore, the cutting-plane angle of the thin film can be more easily changed.

Furthermore, in the present invention, the cutting blade is placed such that the end-edge direction of the tip of the blade is directed at an angle with respect to the direction perpendicular to the feeding direction of the cutting blade in a plane drawn by the tip. Alternatively, a vibrator for vibrating the cutting blade supersonically is provided in the present invention. Therefore, the machinability of the cutting blade is improved, so that the thin film can be cut more easily.

1-8. (canceled)

9. A thin-film slicer comprising:
a base;
a sample holder;
a cutting blade; and,
a feeder;
wherein the sample holder and the cutting blade are placed at predetermined angles with respect to the base such that an angle determined based on a desired cutting-plane angle is formed between a direction of top and bottom sample surfaces opposite each other in the thickness dimension of a thin film and a feeding direction of the cutting blade,
the sample holder sandwiches the thin film at a portion other than the portion to be cut such that the direction of the top and bottom sample surfaces forms the desired cutting-plane angle with respect to the feeding direction of the cutting blade in a state in which the portion of the thin film to be cut protrudes at the cutting-plane angle with respect to the feeding direction of the cutting blade,
wherein the cutting blade is placed such that an end-edge direction of the tip of the blade is directed at an angle with respect to the direction perpendicular to the feeding direction of the cutting blade in a plane drawn by the tip of the cutting blade,
wherein the feeder comprises:
a horizontal linear guide provided in a straight line in parallel to the base; and
a horizontal slider provided movably only in parallel to the base along the horizontal linear guide, the horizontal slider holding the cutting blade such that the tip of the cutting blade is directed horizontally toward the sample surfaces of the thin film, and
the horizontal slider is fed horizontally toward the sample surfaces of the thin film to cut the thin film held by the sample holder with the cutting blade in the feeding direction of the cutting blade to make a thin-film slice having a tilt cutting-plane angle formed between the direction of the sample surfaces of the thin film and the feeding direction of the cutting blade.

10. The thin-film slicer of claim 9, wherein the sample holder holds a strip-shaped thin film such that the longitudinal direction of the strip-shaped thin film is directed to the feeding direction of the cutting blade.

11. The thin-film slicer of claim 9, further comprising an angle changer for changing the angle of the sample holder with respect to the base,
wherein the angle changer adjusts the angle of the sample holder to adjust the angle of the sample surfaces of the thin film with respect to the feeding direction of the cutting blade to set the angle of the cutting plane with respect to the sample surfaces of the thin film to a desired angle.

12. The thin film slicer of claim 9, further comprising a vibrator, wherein the vibrator vibrates the cutting blade supersonically at a predetermined vibration amplitude and a predetermined vibration period in the feeding direction of the cutting blade fed by the feeder.
